(19) United States
(12) Patent Application Publication
(10) Pub. No.: US 2026/0201937 A1
(43) Pub. Date: Jul. 16, 2026

(54) Vibration Isolation Structure

(71) Applicant: NOK CORPORATION, Tokyo (JP)

(72) Inventors: Naoya IWATA, Tottori (JP); Kazuya AIHARA, Nihonmatsu-shi (JP)

(21) Appl. No.: 19/441,293

(22) Filed: Jan. 6, 2026

(30) Foreign Application Priority Data
Jan. 16, 2025 (JP) 2025-006348

(51) Int. Cl. F16F 15/08

(52) U.S. Cl. CPC F16F 15/08; F16F 2224/0208; F16F 2224/025; F16F 2226/04; F16F 2230/0005; F16F 2232/02

(57) ABSTRACT

A vibration isolation structure includes a rotator rotatable about an axis and including a large-diameter portion, a holder holding the rotator and including a recess including an inner wall facing radially inward and a bottom facing in an axial direction, and a vibration isolator between the large-diameter portion and the recess. The vibration isolator includes a transferer including an inner circumferential portion in contact with the large-diameter portion, an outer circumferential portion fitted to the inner wall, and a rear face facing the bottom, a vibration isolation unit between the rear face and the bottom and including a base being a plate facing in the axial direction and an elastomer portion being a film covering a plate surface of the base, and a fixture fixing the transferer and the vibration isolation unit to the holder.

### CROSS REFERENCE TO RELATED APPLICATION

The present application is based on Japanese Priority Document 2025-006348 filed on January 16, 2025, the content of which is incorporated herein by reference.

### BACKGROUND

### Technical Field

The present invention relates to a vibration isolation structure.

### Description of the Background

A known bearing device installed on a rotator, such as a drive shaft of, for example, an automobile, includes an elastic member (elastomer) surrounding a bearing (e.g., Japanese Unexamined Patent Application Publication No. 10-299785). The rotator transmits power from a power unit or a transmission to wheels with tires. Examples of the power unit include a motor and an internal combustion engine. The elastic member surrounding the bearing serves as, in such a bearing device, a vibration isolator that attenuates vibration resulting from rotation of the bearing.

### BRIEF SUMMARY

A holder holding a rotator and a bearing device has a hole fittable with a bearing. When the bearing fitted to the hole has an outer circumference surrounded by an elastomer vibration isolator, the rotation axis of the bearing may be misaligned greater with respect to the center of the hole in the holder.

One or more aspects of the present disclosure are directed to a vibration isolation structure for reducing misalignment of the rotation axis of a rotator with respect to a holder and reducing transmission of vibration to the holder.

An aspect of the present disclosure provides a vibration isolation structure, comprising: a rotator rotatable about an axis and including a large-diameter portion; a holder holding the rotator in a rotatable manner, the holder including an outer surface facing in an axial direction, and a recess recessed from the outer surface and having a larger diameter than the large-diameter portion, the recess including an inner wall facing radially inward and a bottom facing in the axial direction; and a vibration isolator between the large-diameter portion and the recess, the vibration isolator including a transferer being annular, the transferer including an inner circumferential portion in contact with the large-diameter portion, an outer circumferential portion fitted to the inner wall, a first end face facing the bottom, and a second end face facing in a direction opposite to a direction in which the first end face faces, a vibration isolation unit overlapping the first end face in the axial direction between the first end face and the bottom, the vibration isolation unit including a base being a plate facing in the axial direction, and an elastomer portion being a film covering a plate surface of the base, and a fixture fixing the transferer and the vibration isolation unit to the holder.

The technique according to the above aspect of the present disclosure can reduce misalignment of the rotation axis of the rotator with respect to the holder and reduce transmission of vibration to the holder.

### BRIEF DESCRIPTION OF DRAWINGS

FIG. 1 is a front view of a vibration isolation structure according to an embodiment.

FIG. 2 is a partial cross-sectional view of the vibration isolation structure according to the embodiment.

FIG. 3 is an exploded perspective view of a vibration isolator in the embodiment.

FIG. 4 is a partial cross-sectional view of a vibration isolation unit in the embodiment.

FIG. 5 is a front view of the vibration isolation unit in the embodiment, showing its material.

FIG. 6 is a front view of a vibration isolation structure according to a modification.

FIG. 7 is a partial cross-sectional view of the vibration isolation structure according to the modification.

FIG. 8 is a partial cross-sectional view of a vibration isolation unit in a modification.

FIG. 9 is an exploded perspective view of a vibration isolator in a modification.

FIG. 10 is an exploded perspective view of a vibration isolator in a modification.

FIG. 11 is a front view of a vibration isolation unit in the modification, showing its material.

### DETAILED DESCRIPTION

One or more embodiments of the present disclosure will now be described with reference to the drawings. The drawings may not be drawn to scale, and some features may be exaggerated or omitted.

A vibration isolation structure according to one or more embodiments of the present disclosure is used in a structure (not shown) installed on a rotator of, for example, an automobile. The rotator is, for example, a drive shaft included in a power unit or a transmission. Examples of the power unit include a motor and an internal combustion engine.

Hereafter, a direction along the axis of a bearing is referred to as the X-direction. A direction in which the bearing received in a recess being open in the axial direction faces the bottom of the recess is referred to as the negative X-direction. A direction opposite to the negative X-direction is referred to as the positive X-direction. A vertical direction (up-down direction) of the bearing horizontally located in the X-direction is referred to as the Y-direction. In this case, a vertically upward direction is referred to as the positive Y-direction. A vertically downward direction is referred to as the negative Y-direction. A direction perpendicular to the X-direction and the Y-direction is referred to as the Z-direction. A direction away from the central axis of the bearing is referred to as radially outward. A direction toward the central axis of the bearing is referred to as radially inward.

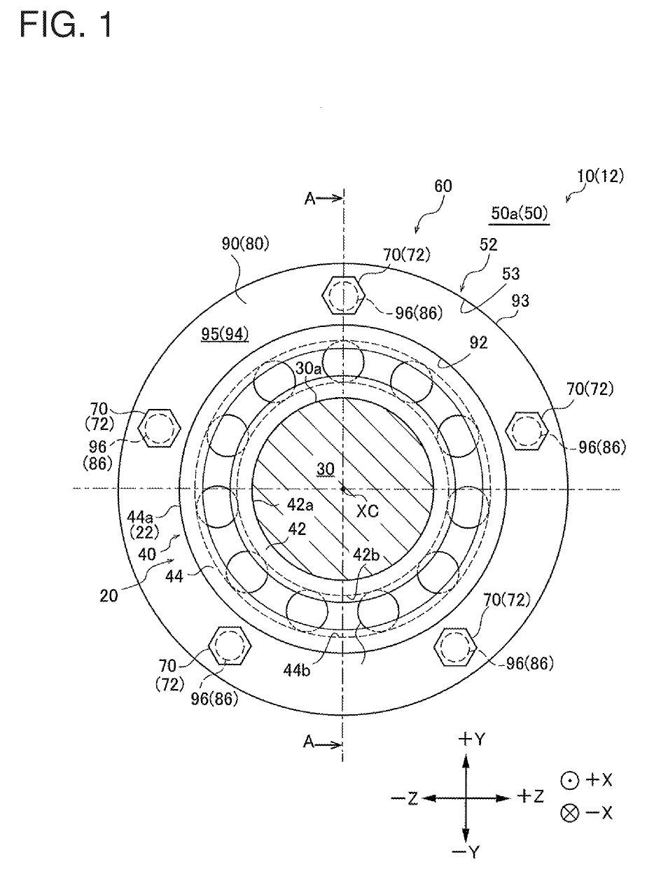

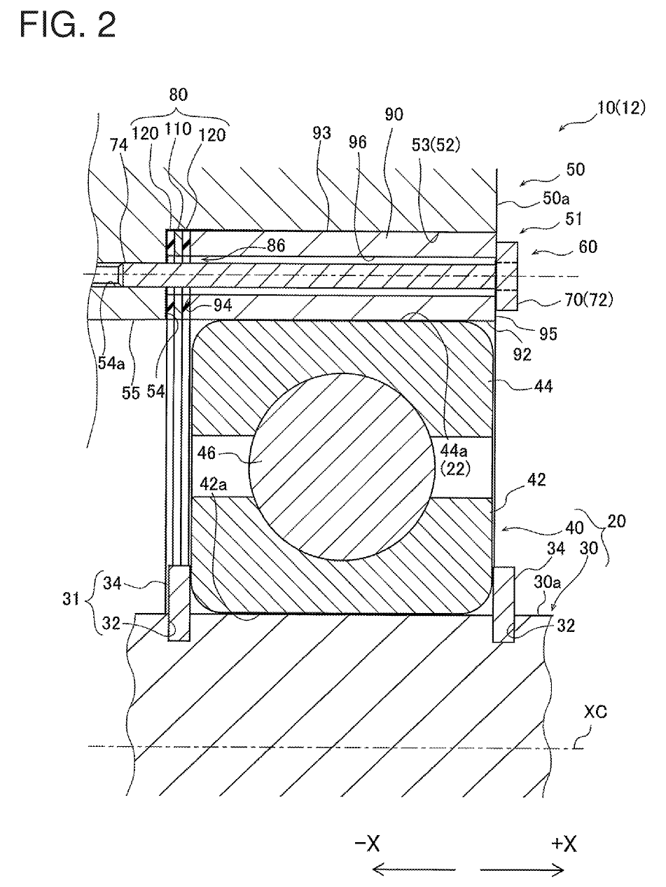

As shown in FIGS. 1 and 2, a structure 10 according to an embodiment includes a rotator 20, a holder 50, and a vibration isolator 60. The rotator 20, the holder 50, and the vibration isolator 60 form a vibration isolation structure 12.

The rotator 20 is connected to a drive (not shown) in the structure 10. The drive includes a motor or a transmission, or both. The rotator 20 receives a rotational force output from the drive. The rotator 20 is rotatable about an axis XC with the drive. The axis XC is an imaginary line extending in the X-direction. The axis XC extends horizontally.

The rotator 20 includes a large-diameter portion. The large-diameter portion is a portion of the rotator 20 having the largest diameter in the structure around the vibration isolator 60 (described later). The large-diameter portion is in contact with the vibration isolator 60.

The rotator 20 includes a shaft 30 and a bearing 40.

As shown in FIG. 2, the shaft 30 is columnar and uniformly extends along the axis XC. The shaft 30 is connected to the drive. The shaft 30 is rotatable about the axis XC with the drive. The shaft 30 is at a predetermined position with respect to the holder 50 (described later) with a known positioner (not shown). The shaft 30 is formed from, for example, steel for a mechanical structure.

The shaft 30 includes a side surface 30a and a positioner 31.

The side surface 30a is a side surface of the columnar shaft 30.

The positioner 31 fixes the bearing 40 (described later) at a predetermined position in the axial direction. The positioner 31 includes two grooves 32 and two retaining rings 34.

The grooves 32 are annular and recessed from the side surface 30a. The two grooves 32 are located at the two ends of the bearing 40 in the axial direction.

Each retaining ring 34 is received in the corresponding groove 32 and protrudes radially outward beyond the side surface 30a. The two retaining rings 34 are in contact with the respective two end faces, facing in the axial direction, of an inner ring 42 in the bearing 40 (described later). In other words, the two retaining rings 34 restrict the position of the bearing 40 in the axial direction. The retaining rings 34 are examples of restrictors.

The bearing 40 surrounds the shaft 30. The bearing in one or more embodiments of the present disclosure is a radial bearing. The bearing 40 is a rolling bearing. As shown in FIGS. 1 and 2, the bearing 40 is a ball bearing. The bearing in one or more embodiments of the present disclosure is not limited to a ball bearing and may be any radial bearing. The bearing 40 may be a roller bearing.

The bearing 40 is supported in a recess 52 on the holder 50 (described later).

The bearing 40 includes multiple rolling elements 46, the inner ring 42, and an outer ring 44. The rolling elements 46 in the bearing 40 being a ball bearing are spherical. As shown in FIG. 1, the multiple rolling elements 46 are annularly arranged about the shaft 30 along rolling surfaces of the inner ring 42 and the outer ring 44.

The inner ring 42 is annular and fitted on the shaft 30. The inner ring 42 is located between the rolling elements 46 and the shaft 30. The inner ring 42 has a central hole 42a.

The central hole 42a is a cylindrical hole located radially inside the annular inner ring 42. The central hole 42a is fitted with the side surface 30a of the shaft 30. The inner ring 42 is thus integrally rotatable with the shaft 30 about the axis XC.

The outer ring 44 is annular and located between the rolling elements 46 and the vibration isolator 60. The outer ring 44 is out of contact with the inner ring 42. The outer ring 44 includes an outer diameter portion 44a.

The outer diameter portion 44a is a cylindrical portion of the annular outer ring 44 and faces radially outward. The outer diameter portion 44a is fitted to a transferer 90 in the vibration isolator 60 (described later). The outer ring 44 including the outer diameter portion 44a is the large-diameter portion in the rotator 20.

The rolling elements 46, the inner ring 42, and the outer ring 44 are formed from, for example, carbon steel for a mechanical structure. The bearing 40 is assembled with inner gaps between the rolling elements 46 and the inner ring 42 and between the rolling elements 46 and the outer ring 44.

The holder 50 holds the shaft 30 with the bearing 40 and the vibration isolator 60 in a rotatable manner. In other words, the holder 50 holds the rotator 20 with the vibration isolator 60 in a rotatable manner.

As shown in FIG. 2, the holder 50 includes an outer surface 50a, a shaft hole 55, and the recess 52. The outer surface 50a faces in the positive X-direction. The shaft hole 55 is cylindrical and extends through the holder 50 in the X-direction. The shaft hole 55 is concentric with the shaft 30 and the recess 52. The shaft hole 55 has a diameter larger than the diameter of the shaft 30 and smaller than the diameter of the recess 52.

The recess 52 is located between the outer surface 50a and the shaft hole 55. More specifically, the recess 52 is recessed from the outer surface 50a. The recess 52 is open in the outer surface 50a. The recess 52 is cylindrical and surrounds the shaft hole 55. The recess 52 has a larger diameter than the shaft hole 55. The recess 52 connects the outer surface 50a and the shaft hole 55.

The recess 52 includes an inner wall 53 and a bottom 54. The recess 52 further includes multiple bolt holes 54a.

The inner wall 53 is a cylindrical surface facing radially inward. The inner wall 53 is fitted to the transferer 90 (described later) in the vibration isolator 60.

The bottom 54 is a flat surface facing in the positive X-direction between the inner wall 53 and the shaft hole 55. The bottom 54 connects the inner wall 53 and the shaft hole 55.

The multiple bolt holes 54a are located in the bottom 54. The bolt holes 54a correspond to multiple bolts 70 (described later). The bolt holes 54a are bottomed holes each having internal threads corresponding to a threaded shank 74 of the bolt 70.

The holder 50 may be formed from a material with a higher coefficient of thermal expansion than the transferer 90 (described later). The holder 50 is formed from, for example, an aluminum-based metal material. The aluminum-based metal material includes a pure aluminum-based material and an aluminum-based alloy.

As shown in FIGS. 1 and 2, the vibration isolator 60 is located between the outer ring 44 in the bearing 40 and the recess 52 on the holder 50. The vibration isolator 60 is in contact with the outer ring 44. The vibration isolator 60 is fixed to and is in contact with the recess 52 (described in detail later).

As shown in FIGS. 1 to 3, the vibration isolator 60 includes the transferer 90, a vibration isolation unit 80, and the multiple bolts 70.

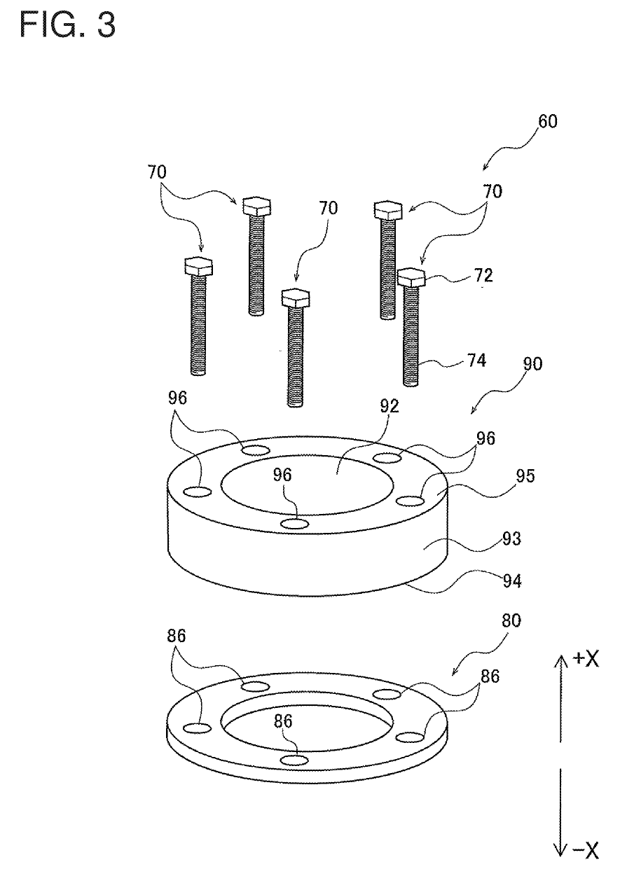

As shown in FIG. 1, the transferer 90 is annular and located between the outer ring 44 and the inner wall 53. More specifically, the transferer 90 is hollow and cylindrical and extends in the X-direction as shown in FIG. 3.

The transferer 90 includes an inner circumferential portion 92, an outer circumferential portion 93, a rear face 94, and a front face 95. The transferer 90 further includes multiple bolt holes 96.

The inner circumferential portion 92 is a cylindrical surface of the transferer 90 and faces radially inward. The inner circumferential portion 92 is in contact with the outer ring 44 in the bearing 40. In particular, the inner circumferential portion 92 is fitted to the outer ring 44.

The outer circumferential portion 93 is a cylindrical surface of the transferer 90 and faces radially outward. The outer circumferential portion 93 is in contact with the inner wall 53 of the recess 52. The outer circumferential portion 93 may be fitted to the inner wall 53.

As shown in FIG. 2, the rear face 94 faces the bottom 54 of the recess 52 (in the negative X-direction). The rear face 94 is in contact with the vibration isolation unit 80 (described later). The rear face 94 is an example of a first end face.

The front face 95 faces in a direction (in the positive X-direction) opposite to the direction in which the rear face 94 faces. The front face 95 is in contact with heads 72 of the bolts 70 (described later). The front face 95 is an example of a second end face.

The multiple bolt holes 96 extend through the transferer 90 from the rear face 94 to the front face 95 in the X-direction. The multiple bolt holes 96 correspond to the multiple bolts 70. In other words, the multiple bolt holes 96 correspond to the multiple bolt holes 54a in the recess 52. Each bolt hole 96 is a through-hole through which the threaded shank 74 of the corresponding bolt 70 extends.

The transferer 90 may be formed from a material with a lower coefficient of thermal expansion than the holder 50. The transferer 90 is formed from, for example, steel for a mechanical structure. The components of the structure 10 may expand thermally, for example, in response to rotation of the shaft 30 and the bearing 40 or based on the temperature of the installation environment. When the components of the structure 10 expand thermally, the transferer 90 having a lower coefficient of thermal expansion than the holder 50 may be fitted to the inner wall 53 with a clearance fit.

The transferer 90 receives vibration resulting from rotation of the shaft 30 and the bearing 40. The transferer 90 transfers the received vibration to the vibration isolation unit 80.

As shown in FIG. 2, the vibration isolation unit 80 is located between the rear face 94 of the transferer 90 and the bottom 54 of the recess 52. The vibration isolation unit 80 overlaps the rear face 94 in the axial direction. As shown in FIG. 3, the vibration isolation unit 80 is hollow and cylindrical, and extends in the X-direction. The vibration isolation unit 80 is annular along the rear face 94.

The vibration isolation unit 80 includes an inward-facing portion 82, an outward-facing portion 83, a rear face 84, and a front face 85. The vibration isolation unit 80 further includes multiple bolt holes 86.

The inward-facing portion 82 is a cylindrical surface facing radially inward.

The outward-facing portion 83 is a cylindrical surface facing radially outward.

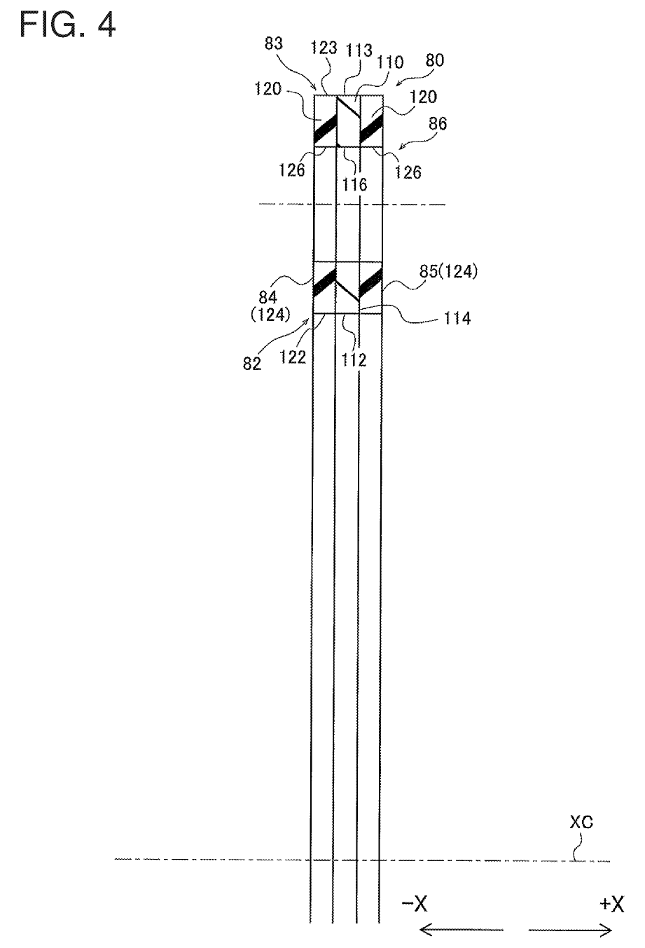

As shown in FIG. 4, the rear face 84 faces the bottom 54 of the recess 52 (in the negative X-direction). The rear face 84 is in contact with the bottom 54.

The front face 85 faces in a direction (in the positive X-direction) opposite to the direction in which the rear face 84 faces. The front face 85 is in contact with the rear face 94 of the transferer 90.

The multiple bolt holes 86 extend through the vibration isolation unit 80 from the rear face 84 to the front face 85 in the X-direction. The multiple bolt holes 86 correspond to the multiple bolts 70. In other words, the multiple bolt holes 86 correspond to the multiple bolt holes 54a in the recess 52. In still other words, the multiple bolt holes 86 correspond to the multiple bolt holes 96 in the transferer 90. Each bolt hole 86 is a through-hole through which the threaded shank 74 of the corresponding bolt 70 extends.

The vibration isolation unit 80 includes a base 110 and elastomer portions 120. More specifically, the vibration isolation unit 80 includes the base 110 and two elastomer portions 120 layered in the X-direction as shown in FIG. 4.

The base 110 is a thin plate facing in the X-direction. The base 110 is formed from, for example, steel for a mechanical structure. The base 110 may be formed from a resin material.

The base 110 has through-holes corresponding to the multiple bolt holes 86. The base 110 may have a thickness smaller than or equal to 1 mm.

The elastomer portions 120 are elastomer films covering the plate surfaces of the base 110. The two elastomer portions 120 cover the respective two plate surfaces of the base 110. The elastomer portions 120 may be formed from, for example, ethylene propylene rubber (ethylene propylene diene monomer or EPDM), acrylic rubber (alkyl acrylate copolymer or ACM), nitrile rubber (nitrile butadiene rubber or NBR), or fluoro rubber (fluorine kautschuk material or FKM).

The elastomer portions 120 have through-holes corresponding to the multiple bolt holes 86. The two elastomer portions 120 may have a total thickness smaller than or equal to 1 mm. A single elastomer portion 120 may have a smaller thickness than the plate of the base 110. A single elastomer portion 120 may have a thickness smaller than or equal to 0.5 mm.

The elastomer portions 120 may be integral with the base 110. The two elastomer portions 120 define the rear face 84 and the front face 85 of the vibration isolation unit 80. The two elastomer portions 120 are respectively in contact with the rear face 94 of the transferer 90 and the bottom 54 of the recess 52.

The vibration isolation unit 80 including the base 110 can be handled more easily as a member including the elastomer portions 120.

The vibration isolation unit 80 receives vibration from the transferer 90. The elastomer portions 120 attenuate vibration transmitted to the vibration isolation unit 80.

The vibration isolation unit 80 is not directly in contact with the shaft 30 or the bearing 40. Thus, the vibration isolation unit 80 is out of contact with the rotator 20.

As shown in FIG. 3, the bolts 70 are columnar and extend in the X-direction. As shown in FIG. 2, the bolts 70 extend through the bolt holes 96 and 86 to hold the transferer 90 and the vibration isolation unit 80 between the bolts 70 and the holder 50 and are fastened to the respective bolt holes 54a. The bolts 70 are fastened with the transferer 90 and the vibration isolation unit 80 held between the bolts 70 and the holder 50, fixing the transferer 90 and the vibration isolation unit 80 to the holder 50. The bolts 70 are examples of fixtures. The bolts 70 are examples of fasteners. Each bolt 70 includes the threaded shank 74 and the head 72.

The threaded shank 74 is columnar and extends in the X-direction. The threaded shank 74 has a smaller diameter than the bolt holes 96 and 86. The threaded shank 74 includes external threads. The external threads are threads corresponding to internal threads on the bolt hole 54a. The external threads extend in the positive X-direction from an end of the threaded shank 74 in the negative X-direction.

The head 72 is located at the end of the threaded shank 74 in the positive X-direction. The head 72 has a larger diameter than the bolt holes 96 and 86. The head 72 is in contact with the front face 95 of the transferer 90. When each bolt 70 is fastened, the head 72 applies a fastening force to the transferer 90. The bolts 70 fix the transferer 90 and the vibration isolation unit 80 to the holder 50 with the fastening force.

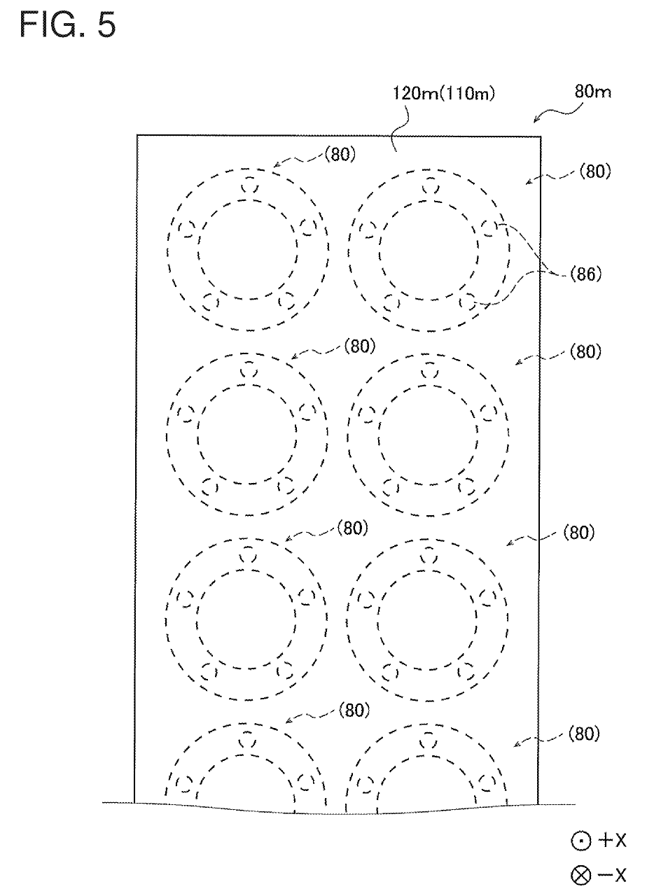

A method for manufacturing the vibration isolation unit 80 will now be described with reference to FIG. 5. As shown in FIG. 5, the vibration isolation unit 80 is formed by punching (or laser-cutting) a flat base plate 80m. The base plate 80m includes a substrate 110m and two elastomer films 120m layered in the X-direction. The substrate 110m corresponds to the base 110 in the vibration isolation unit 80. The elastomer films 120m correspond to the elastomer portions 120 in the vibration isolation unit 80. The elastomer films 120m are integrally formed with the substrate 110m by lining or coating the two surfaces of the substrate 110m with an elastomer.

The profile of the vibration isolation unit 80 and the bolt holes 86 are defined by punching.

Multiple vibration isolation units 80 may be obtained from a single base plate 80m.

### Advantages and Effects

The advantages and effects of the vibration isolation structure 12 according to the embodiment will now be described.

The vibration isolation structure 12 includes the vibration isolator 60 including the transferer 90, the vibration isolation unit 80, and the bolts 70.

The transferer 90 is fitted to the bearing 40 in the rotator 20. The vibration isolation unit 80 is out of contact with the rotator 20. The transferer 90 and the vibration isolation unit 80 are fixed to the holder 50 with the bolts 70. More specifically, the bolts 70 reduce misalignment between the transferer 90 and the vibration isolation unit 80 resulting from vibration transmitted from the rotator 20. The factors of the vibration isolator 60 affecting misalignment of the rotation axis of the rotator 20 with respect to the holder 50 are limited to assembly errors and processing accuracy. The vibration isolation structure 12 including the vibration isolator 60 can thus reduce the misalignment of the rotation axis of the rotator 20 with respect to the holder 50.

The vibration of the rotator 20 is transmitted to the holder 50 through the vibration isolator 60. The vibration of the rotator 20 is thus not directly transmitted to the holder 50. In the vibration isolator 60, the elastomer portions 120 in the vibration isolation unit 80 attenuate vibration transmitted through the transferer 90 from the rotator 20. In particular, the elastomer portions 120 being films can efficiently attenuate transmitted low-magnitude vibration. In this manner, the vibration isolation structure 12 can reduce transmission of vibration from the rotator 20 to the holder 50.

The vibration isolation structure 12 can thus reduce misalignment of the rotation axis of the rotator 20 with respect to the holder 50 and reduce transmission of vibration to the holder 50.

In particular, the large-diameter portion in the rotator 20 is the bearing 40, allowing the vibration isolation structure 12 to reduce misalignment of the rotation axes of the bearing 40 and the shaft 30 with respect to the holder 50 and reduce transmission of vibration to the holder 50.

The rotator 20 may be heated when rotating. Heat from the rotator 20 is conducted to the holder 50 through the transferer 90. Thus, heat from the rotator 20 is not directly conducted to the holder 50. In other words, the vibration isolation structure 12 can reduce direct conduction of heat from the rotator 20 to the holder 50. This reduces the likelihood that the holder 50 expands thermally as the rotator 20 rotates. Although the rotator 20 is heated when rotating, the degree of fitting between the holder 50 and the transferer 90 fitted to the rotator 20 is less likely to change. The vibration isolation structure 12 thus reduces misalignment of the rotator 20 with respect to the holder 50 resulting from thermal expansion of the holder 50.

The elastomer portions 120 cover the two plate surfaces of the base 110. The vibration isolation structure 12 thus improves vibration isolation of the vibration isolator 60 as compared with when an elastomer portion covers one surface alone of the base 110.

The vibration isolation unit 80 is annular along the rear face 94 of the transferer 90. More specifically, the vibration isolation unit 80 is entirely in close contact with the transferer 90. In this case, the vibration isolation structure 12 can transmit, through the entire rear face 94, vibration transmitted to the transferer 90 to the vibration isolation unit 80 and attenuate the vibration. The vibration isolation structure 12 thus improves vibration isolation of the vibration isolator 60 as compared with when a vibration isolator is partially in contact with the rear face 94.

The vibration isolation structure 12 reduces the number of work-hours for assembling the vibration isolator 60 as compared with when a vibration isolator includes multiple washers.

When the holder 50 expands thermally, the transferer 90 is fitted to the inner wall 53 of the holder 50 with a clearance fit. In this case, the vibration transmitted from the rotator 20 to the transferer 90 is less likely to be directly transmitted from the transferer 90 to the holder 50. The vibration isolation structure 12 thus more effectively reduces transmission of vibration to the holder 50 when the holder 50 expands thermally.

In particular, the holder 50 is formed from a material with a higher coefficient of thermal expansion than the transferer 90. More specifically, the holder 50 is formed from an aluminum alloy-based material. The transferer 90 is formed from steel for a mechanical structure. When the components of the structure 10 expand thermally, the transferer 90 is likely to be fitted to the inner wall 53 with a clearance fit. The vibration isolation structure 12 thus more effectively reduces transmission of vibration to the holder 50 when the holder 50 with a higher coefficient of thermal expansion than the transferer 90 expands thermally.

The elastomer portions 120 in the vibration isolation unit 80 are films. In particular, the elastomer portions 120 have a total thickness smaller than or equal to 1 mm. When the transferer 90 and the vibration isolation unit 80 are fixed to the holder 50 by fastening the multiple bolts 70, the fastening force from the bolts 70 compresses the elastomer portions 120 in the thickness direction. The elastomer portions 120 being films have a greater spring constant in the thickness direction than when the elastomer portions are plates each having a greater thickness than the films. In this case, each elastomer portion 120 has a large restoring force for restoring from the compressed state in the thickness direction. In particular, the elastomer portions 120 have a total thickness smaller than or equal to 1 mm and thus each have a restoring force for restoring from the compressed state in the thickness direction increasing based on the spring constant corresponding to the thickness of the elastomer portion 120. In this case, when the elastomer portions 120 deteriorate, for example, over time or under heat, the fastening force from the bolts 70 is less likely to decrease, and the bolts 70 are less likely to be loosened. The vibration isolation structure 12 thus has a smaller decrease in the fastening force from the bolts 70 resulting from deterioration of the elastomer portions 120.

Although embodiments of the present invention have been described by way of example, the present invention is not limited to the embodiments described above, and may be modified, changed, or varied in various manners within the scope of technical idea of the present invention.

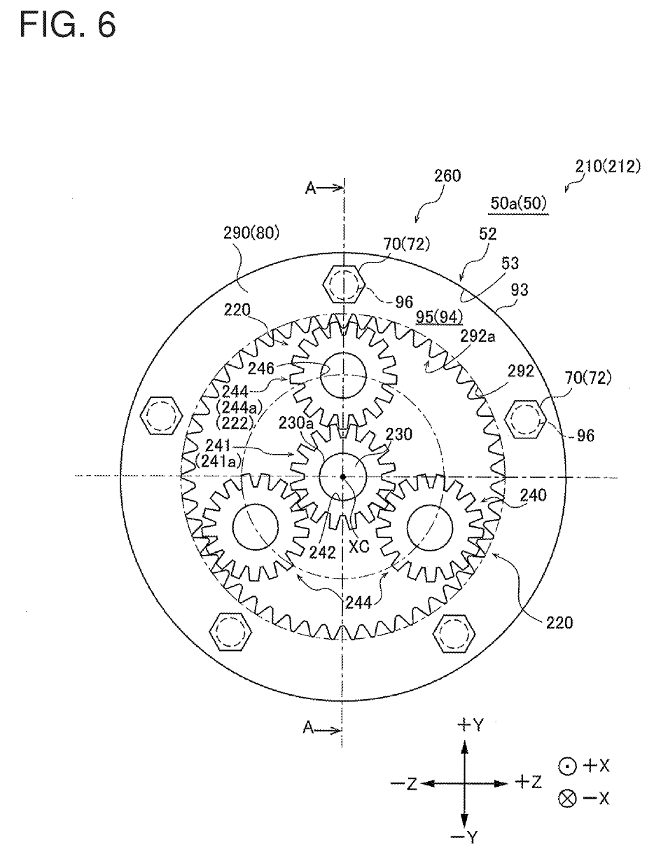

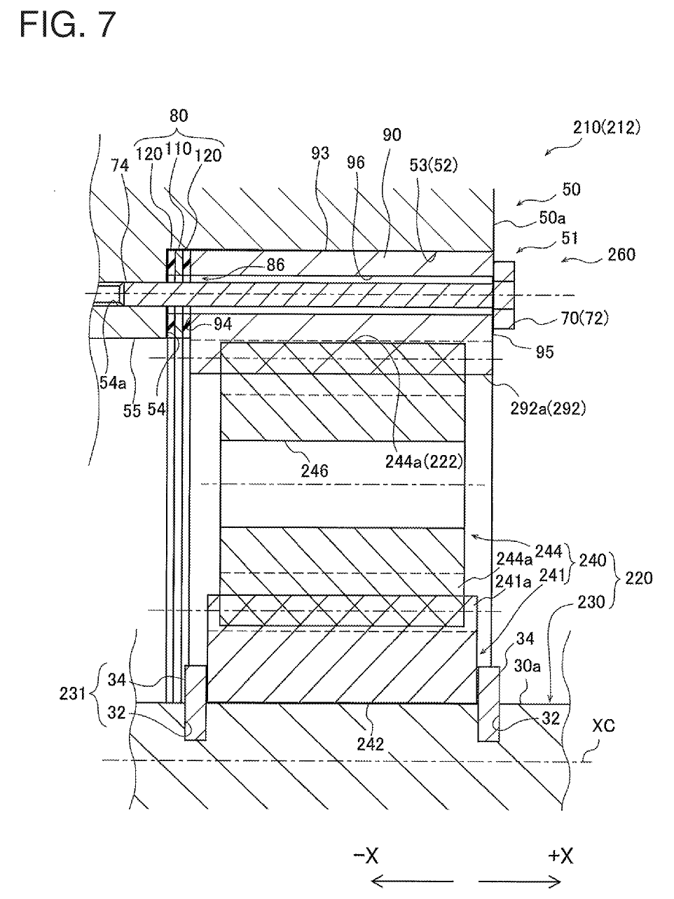

The large-diameter portion in the rotator 20 in the embodiment is the outer ring 44 in the bearing 40. However, the large-diameter portion in the rotator in one or more embodiments of the present disclosure is not limited to a bearing. The large-diameter portion in the rotator in one or more embodiments of the present disclosure may correspond to rolling portions such as multiple planetary gears 244 in a rotator 220 shown in FIGS. 6 and 7. The rolling portions are rotatable to roll on an inner circumferential portion of the transferer relative to the inner circumferential portion. A vibration isolation structure 212 including the rotator 220 according to a modification of the present disclosure will be described below with reference to FIGS. 6 and 7. For the vibration isolation structure 212, the same components as the vibration isolation structure 12 according to the embodiment will be described using the same reference numerals and names of the components.

As shown in FIGS. 6 and 7, a structure 210 includes the rotator 220 and a vibration isolator 260 in place of the rotator 20 and the vibration isolator 60 in the structure 10. The rotator 220, the holder 50, and the vibration isolator 260 form the vibration isolation structure 212.

The rotator 220 includes a shaft 230 and a gear group 240 in place of the shaft 30 and the bearing 40 in the structure 10.

The shaft 230 includes a positioner 231 in place of the positioner 31 in the shaft 30. The positioner 231 further includes a rotational position determiner (not shown), unlike the positioner 31. The rotational position determiner fixes the rotational position of a sun gear 241 (described later) relative to the shaft 230. The positioner includes, for example, a parallel key and a shaft keyway. The shaft keyway is recessed from the side surface 30a of the shaft 230.

As shown in FIG. 6, the gear group 240 includes the sun gear 241 and the planetary gears 244. More specifically, the rotator 220 is a part of a planetary gear assembly.

The sun gear 241 is a spur gear surrounding the shaft 230. The position of the sun gear 241 in the axial direction is restricted by the two retaining rings 34 on the shaft 230.

The sun gear 241 includes a first tooth group 241a and a central hole 242. The first tooth group 241a includes multiple external teeth on the sun gear 241, which is a spur gear.

The central hole 242 is cylindrical and extends through a central portion of the sun gear 241 in the axial direction. The central hole 242 is fitted with the side surface 30a of the shaft 230. The central hole 242 includes a hole keyway corresponding to the rotational position determiner in the shaft 230. The sun gear 241 is thus rotatable about the axis XC together with the shaft 230.

The planetary gears 244 are spur gears located between the sun gear 241 and the vibration isolator 260. As shown in FIG. 6, the gear group 240 includes the three planetary gears 244 arranged about the sun gear 241 at equal intervals.

Each planetary gear 244 includes a second tooth group 244a and a central hole 246. The second tooth group 244a includes multiple external teeth on the planetary gear 244, which is a spur gear. The second tooth group 244a can mesh with the first tooth group 241a on the sun gear 241 and a third tooth group 292a on a transferer 290 (described later).

The central hole 246 is cylindrical and extends through a central portion of the planetary gear 244 in the axial direction. The central hole 246 is supported by a gear support (not shown). The gear support supports the three planetary gears 244 about their respective central axes in a rotatable manner. The gear support further restricts the positions of the planetary gears 244 in the axial direction. The gear support is freely rotatable about the axis XC relative to the shaft 230 and the vibration isolator 260. Thus, the three planetary gears 244 are rotatable while maintaining a distance between the adjacent planetary gears 244 and rolling and moving on an inner circumferential portion 292 including the third tooth group 292a as the sun gear 241 rotates. As described above, the planetary gears 244 correspond to the large-diameter portion in the shaft 230.

The vibration isolator 260 includes the transferer 290 in place of the transferer 90 in the vibration isolator 60. The transferer 290 includes the inner circumferential portion 292 in place of the inner circumferential portion 92 in the transferer 90. The inner circumferential portion 292 further includes the third tooth group 292a, unlike the inner circumferential portion 92.

The third tooth group 292a includes multiple inner teeth protruding radially inward from the inner circumferential portion 92. The third tooth group 292a can mesh with the second tooth groups 244a on the planetary gears 244. The root of the third tooth group 292a is the inner circumferential portion 292.

The transferer 290 receives vibration resulting from rotation of the shaft 230. The transferer 290 further receives vibration resulting from meshing between the tooth groups 241a, 244a, and 292a. The transferer 290 transfers the vibration to the vibration isolation unit 80.

The elastomer portions 120 attenuate the vibration transferred to the vibration isolation unit 80. The vibration isolation structure 212 can thus reduce misalignment of the rotation axis of the rotator 220 with respect to the holder 50 and reduce transmission of vibration to the holder 50 with the large-diameter portion in the rotator 220 corresponding to the planetary gears 244 as the rolling portions as well.

The rotator 220 including the planetary gears 244 as the rolling portions is a part of the planetary gear assembly. However, the rolling portions in one or more embodiments of the present disclosure are not limited to be in the form of the planetary gear assembly when the rolling portions are rotatable to roll on the inner circumferential portion of the transferer relative to the inner circumferential portion. The rolling portions in one or more embodiments of the present disclosure may form an eccentric gear assembly. The rolling portions in one or more embodiments of the present disclosure may form a strain wave gear assembly.

The rolling portions in one or more embodiments of the present disclosure are not limited to spur gears. The rolling portions in one or more embodiments of the present disclosure may be pin gears. The rolling portions in one or more embodiments of the present disclosure may be helical gears.

When the vibration isolation structure including the multiple bolts 70 according to one or more embodiments of the present disclosure surrounds the gear assembly, the number of bolts 70 may be relatively prime to the number of teeth on each gear included in the gear assembly.

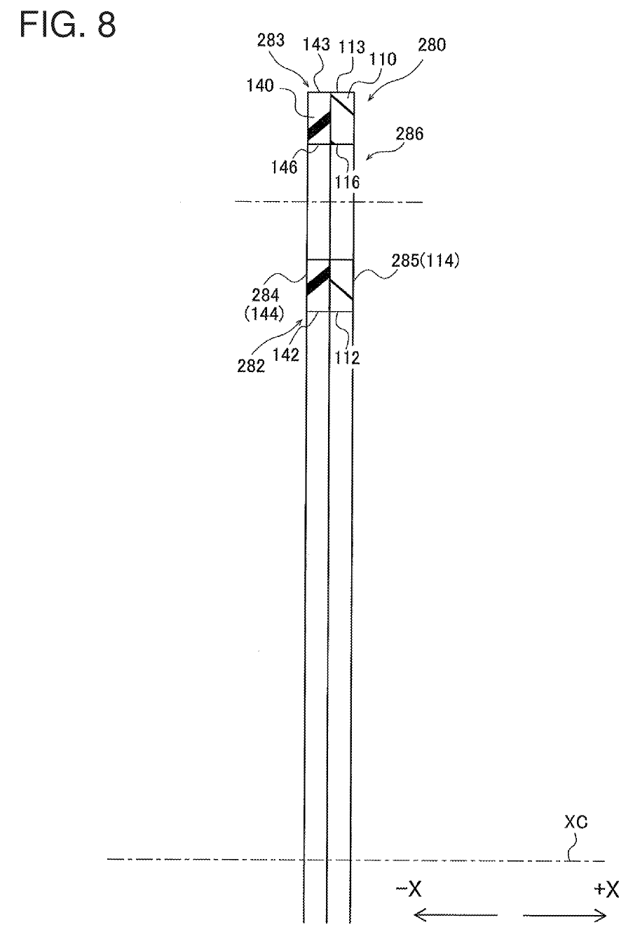

The vibration isolation unit 80 includes the two elastomer portions 120 covering the two plate surfaces of the base 110. However, the vibration isolation unit in one or more embodiments of the present disclosure may not include the two elastomer portions 120. The vibration isolation unit in one or more embodiments of the present disclosure may include an elastomer portion 140 covering one plate surface alone of the base 110, as a vibration isolation unit 280 shown in FIG. 8.

In this case, the elastomer portion 140 may have a thickness smaller than or equal to 1 mm. More specifically, the elastomer portion 140 may have a thickness smaller than or equal to 0.5 mm.

The vibration isolation unit 280 may be located with the elastomer portion 140 in contact with the bottom of the recess. The vibration isolation unit 280 may be located with the elastomer portion 140 in contact with the first end face of the transferer.

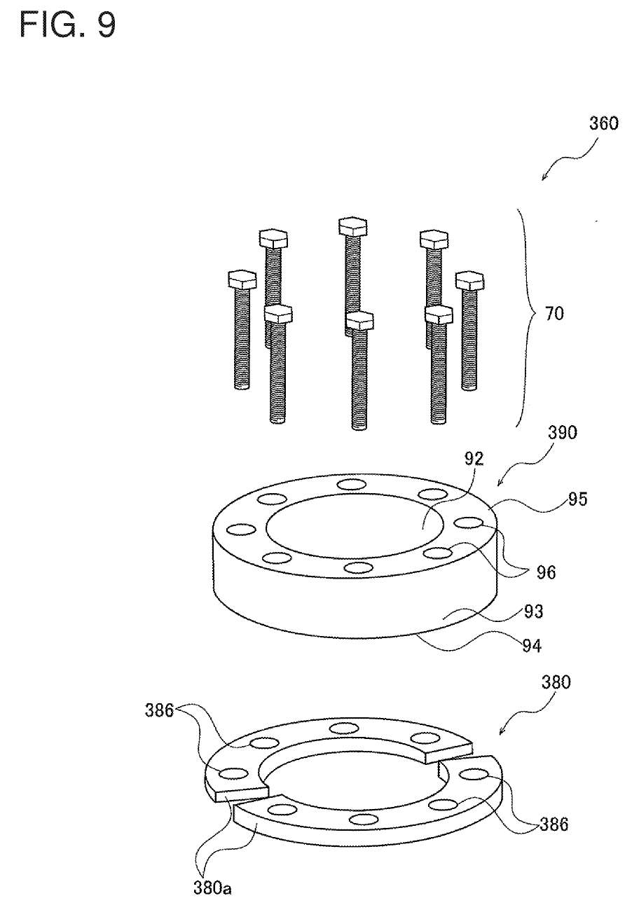

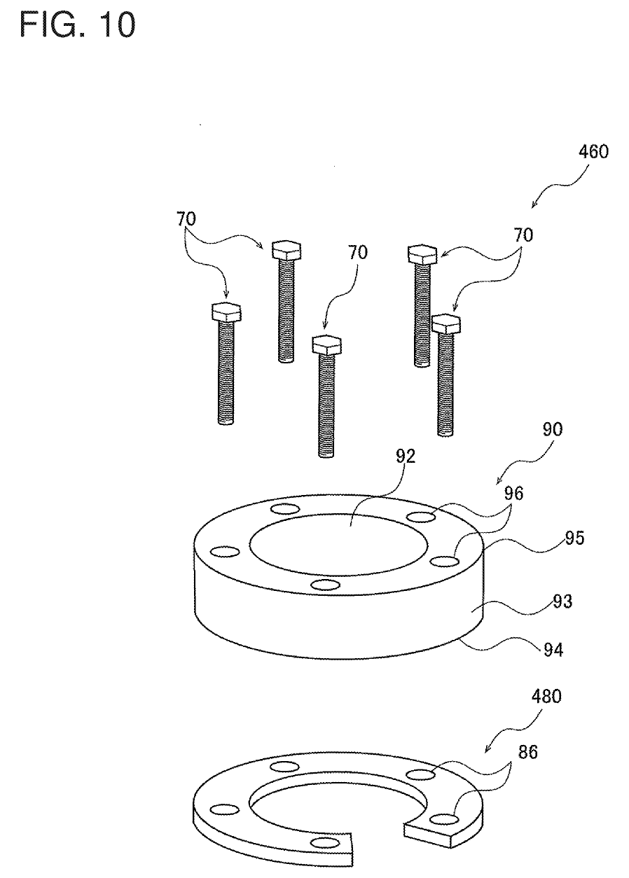

The vibration isolation unit 80 is annular along the rear face 94 of the transferer 90. However, the vibration isolation unit in one or more embodiments of the present disclosure is not limited to being annular. The vibration isolation unit in one or more embodiments of the present disclosure may include two C-shaped split portions 380a, as a vibration isolation unit 380 shown in FIG. 9. The two split portions 380a are annually arranged to overlap the transferer 90 in the axial direction. The vibration isolation unit in one or more embodiments of the present disclosure may be C-shaped along the rear face 94 of the transferer 90, as a vibration isolation unit 480 shown in FIG. 10.

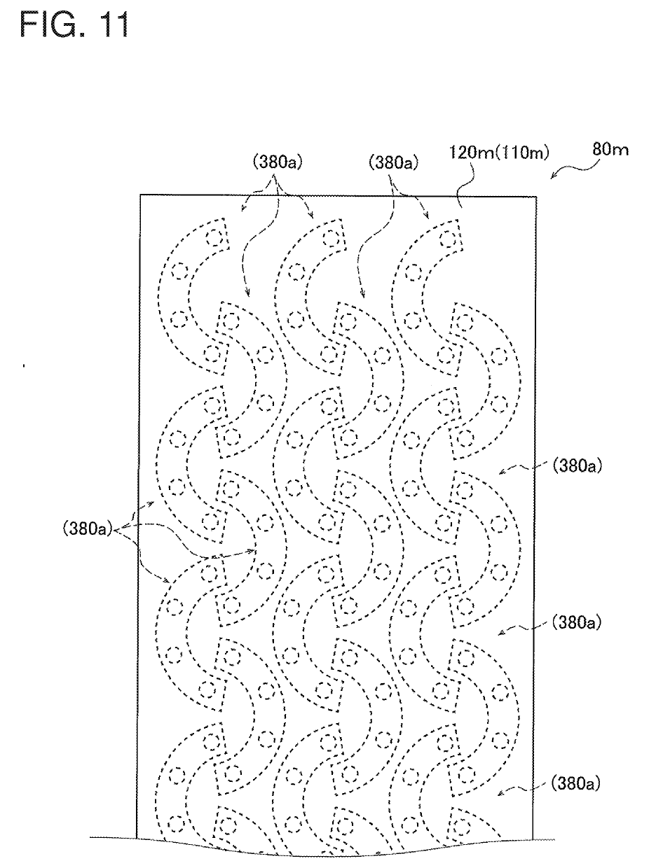

The vibration isolation unit including a C-shaped member can have higher productivity. To explain this productivity, for example, the split portions 380a in the vibration isolation unit 380 are formed by punching the flat base plate 80m. In this process, the split portions 380a being C-shaped allow molds for forming the multiple split portions 380a to be placed on the base plate 80m as shown in FIG. 11. More specifically, the molds for forming the multiple split portions 380a can be arranged to allow the opening of one split portion 380a being C-shaped to receive ends of other split portions 380a. The multiple split portions 380a are arranged in a direction in which the base plate 80m extends. Each split portion 380a has a length in the width direction of the base plate 80m shorter than the outermost diameter of the vibration isolation unit 80. The vibration isolation unit 380 thus increases the number of vibration isolation units obtained from the base plate 80m with the same dimensions as compared with when the vibration isolation units 80 are obtained. More specifically, the base plate 80m can undergo punching more efficiently to produce the vibration isolation unit 380.

When the vibration isolation unit includes the C-shaped members, some of the bolt holes corresponding to the bolts 70 in the vibration isolation unit may be located near the two ends of each C-shaped member. This structure reduces the likelihood that the vibration isolation unit warps and separates as the bolts are fastened.

The vibration isolation unit 80 includes the base 110 and the two elastomer portions 120 layered in the thickness direction. However, the vibration isolation unit in one or more embodiments of the present disclosure may include a base fully surrounded by an elastomer film along the periphery in a sectional view. In this case, the vibration isolation unit in one or more embodiments of the present disclosure may be formed by, for example, lining or coating an annular base with an elastomer.

Each bolt hole 54a in the holder 50 has internal threads corresponding to the bolt 70. However, each of the multiple bolt holes in the holder in one or more embodiments of the present disclosure may not have internal threads. Each bolt hole in the holder in one or more embodiments of the present disclosure may be a through-hole through which the threaded shank 74 of the corresponding bolt 70 extends. In this case, multiple nuts corresponding to the multiple bolt holes and the multiple bolts 70 are located on the outer surface 50a and the surface opposite to the bottom 54 of the holder 50. In this case, the multiple bolts 70 are fastened to the respective nuts with the vibration isolator and the holder 50 held between the bolts 70 and the nuts, fixing the vibration isolator to the holder 50.

The vibration isolator 60 includes the multiple bolts 70 as the fasteners that are fixtures. However, the fasteners in one or more embodiments of the present disclosure are not limited to bolts. The fasteners in one or more embodiments of the present disclosure may form a clamping assembly. The fixtures in one or more embodiments of the present disclosure are not limited to fasteners. The fixtures in one or more embodiments of the present disclosure may be adhesives.

### Reference Signs List

10 structure

12 vibration isolation structure

20 rotator

30 shaft

40 bearing

42 inner ring

44 outer ring (example of large-diameter portion)

46 rolling element

50 holder

52 recess

53 inner wall

54 bottom

54a bolt hole

60 vibration isolator

70 bolt (example of fastener and example of fixture)

80 vibration isolation unit

82 inward-facing portion

83 outward-facing portion

84 rear face

85 front face

86 bolt hole

90 transferer

92 inner circumferential portion

93 outer circumferential portion

94 rear face (example of first end face)

95 front face (example of second end face)

96 bolt hole

110 base

120 elastomer portion

210 structure

212 vibration isolation structure

220 rotator

230 shaft

240 gear group

241 sun gear

241a first tooth group

242 central hole

244 planetary gear (example of large-diameter portion)

244a second tooth group

246 central hole

290 transferer

292 third tooth group

What is claimed is:

1. A vibration isolation structure, comprising:
a rotator rotatable about an axis and including a large-diameter portion;
a holder holding the rotator in a rotatable manner, the holder including
an outer surface facing in an axial direction, and
a recess recessed from the outer surface and having a larger diameter than the large-diameter portion, the recess including an inner wall facing radially inward and a bottom facing in the axial direction; and
a vibration isolator between the large-diameter portion and the recess, the vibration isolator including
a transferer being annular, the transferer including
an inner circumferential portion in contact with the large-diameter portion,
an outer circumferential portion fitted to the inner wall,
a first end face facing the bottom, and
a second end face facing in a direction opposite to a direction in which the first end face faces,
a vibration isolation unit overlapping the first end face in the axial direction between the first end face and the bottom, the vibration isolation unit including
a base being a plate facing in the axial direction, and
an elastomer portion being a film covering a plate surface of the base, and
a fixture fixing the transferer and the vibration isolation unit to the holder.

2. The vibration isolation structure according to claim 1, wherein
the elastomer portion includes a plurality of elastomer portions covering two plate surfaces of the base.

3. The vibration isolation structure according to claim 1, wherein
the vibration isolation unit annularly extends along the first end face.

4. The vibration isolation structure according to claim 1, wherein
the transferer is fitted to the inner wall with a clearance fit when the holder expands thermally.

5. The vibration isolation structure according to claim 1, wherein
the holder comprises an aluminum alloy-based material.

6. The vibration isolation structure according to claim 1, wherein
the fixture includes a fastener in contact with the second end face, and the fastener applies a fastening force to the transferer to fix the transferer and the vibration isolation unit to the holder, and
the elastomer portion has a thickness smaller than or equal to 1 mm.

7. The vibration isolation structure according to claim 1, wherein
the rotator includes a bearing, and
the large-diameter portion is the bearing.

8. The vibration isolation structure according to claim 1, wherein
the rotator includes a rolling portion rotatable to roll on the inner circumferential portion relative to the inner circumferential portion, and
the large-diameter portion is the rolling portion.

9. The vibration isolation structure according to claim 2, wherein
the vibration isolation unit annularly extends along the first end face.

10. The vibration isolation structure according to claim 2, wherein
the transferer is fitted to the inner wall with a clearance fit when the holder expands thermally.

11. The vibration isolation structure according to claim 3, wherein
the transferer is fitted to the inner wall with a clearance fit when the holder expands thermally.

12. The vibration isolation structure according to claim 2, wherein
the holder comprises an aluminum alloy-based material.

13. The vibration isolation structure according to claim 3, wherein
the holder comprises an aluminum alloy-based material.

14. The vibration isolation structure according to claim 4, wherein
the holder comprises an aluminum alloy-based material.

15. The vibration isolation structure according to claim 2, wherein
the fixture includes a fastener in contact with the second end face, and the fastener applies a fastening force to the transferer to fix the transferer and the vibration isolation unit to the holder, and
the elastomer portion has a thickness smaller than or equal to 1 mm.

16. The vibration isolation structure according to claim 3, wherein
the fixture includes a fastener in contact with the second end face, and the fastener applies a fastening force to the transferer to fix the transferer and the vibration isolation unit to the holder, and
the elastomer portion has a thickness smaller than or equal to 1 mm.

17. The vibration isolation structure according to claim 4, wherein
the fixture includes a fastener in contact with the second end face, and the fastener applies a fastening force to the transferer to fix the transferer and the vibration isolation unit to the holder, and
the elastomer portion has a thickness smaller than or equal to 1 mm.

18. The vibration isolation structure according to claim 5, wherein
the fixture includes a fastener in contact with the second end face, and the fastener applies a fastening force to the transferer to fix the transferer and the vibration isolation unit to the holder, and
the elastomer portion has a thickness smaller than or equal to 1 mm.

19. The vibration isolation structure according to claim 2, wherein
the rotator includes a bearing, and
the large-diameter portion is the bearing.

20. The vibration isolation structure according to claim 3, wherein
the rotator includes a bearing, and
the large-diameter portion is the bearing.
